(19) United States
(12) Patent Application Publication
(10) Pub. No.: US 2005/0002521 A1
(43) Pub. Date: Jan. 6, 2005

(54) Device for storing a mobile telephone

(76) Inventor: Georg Maier, Mohrendorf (DE)

Correspondence Address: SCHIFF HARDIN, LLP;PATENT DEPARTMENT, 6600 SEARS TOWER, CHICAGO, IL, 60606-6473, US

(21) Appl. No.: 10/859,645

(22) Filed: Jun. 3, 2004

(30) Foreign Application Priority Data
Jun. 3, 2003 (DE) 103 25 275.4

(51) Int. Cl. H04M 1/00

(52) U.S. Cl. 379/455

(57) ABSTRACT

A device to store a mobile telephone having a base with a post extending therefrom and an adjustable telephone support having the form of a medical patient positioning device being attached to the post. The storage device, for example, serves as a storage location for a cell phone or a wireless telephone and a footrest of the medical patient positioning device has a slot and an arrangement to enable charging the phone while being stored on the storage device.

### BACKGROUND OF THE INVENTION

The present invention concerns an apparatus to store a mobile telephone with a telephone support, for example the storing of a cell phone.

Storage shelves or racks serve as a storage location for cell phones or cordless phones, for example to charge the telephone or also for storage, for example, on a desk or writing table. There are a plurality of cell phone storages that, for example, exhibit figures based on a chair, a deck chair or also a beach chair.

### SUMMARY OF THE INVENTION

The present invention is directed to an object to provide a telephone storage so that there is a connection which is visible between the telephone storage and, for example, a product to be sold or bought.

This object is inventively achieved by an apparatus or device to store a mobile phone, said apparatus having a floor plate, a post and a telephone support in the form of a medical patient positioning device, which is adjustably attached to the post.

A model of a medical diagnostic device that, in addition to the optical shaping, simultaneously takes on a functional task of storing or retaining a mobile telephone is achieved via the design of an apparatus in the form of a medical patient positioning device, to store the mobile telephone. The apparatus has a base, a post and the adjustable telephone support, which is attached thereto.

The support surface of the mobile telephone can be adjusted when the telephone support is laterally attached to the post so that it can rotate around a transverse axis to allow the telephone support to be tilted around this axis.

A model of an x-ray technical component can be attached to the telephone support in an advantageous manner via an elbow or C-structure.

It has proven to be advantageous when the telephone support exhibits an elbow or a flange at the bottom end in the form of a footrest. This can be provided with a slot in the middle, so that a charge cable for the cell phone can be connected to the cell phone without disturbing the phone on the support.

The charge cable can be provided with a wide plug when the footrest adjacent the slot exhibits an oblong or elongated hole or aperture aligned transverse to the slot.

The x-ray technical components, which are included with the telephone support, can copy an x-ray radiator and/or x-ray image intensifier.

In an advantageous manner, the telephone support can exhibit a groove on the side in which is located, at one location, a rectangular elevation that represents the planar x-ray detector below a patient positioning device.

It has proven to be advantageous when the apparatus is made from wood and/or from plastic.

The object is inventively also achieved via use of a model of a medical diagnostic apparatus as a storage for the mobile telephone.

Other advantages and features of the invention will be readily apparent from the following description, the claims and drawings.

### BRIEF DESCRIPTION OF THE DRAWINGS

FIG. 1 is a perspective view taken from the front, left side of a cell phone holder having the form of a universal x-ray apparatus;

FIG. 2 is a perspective view taken from the front, right side of the cell phone holder of FIG. 1;

FIG. 3 is an end view of a telephone support of the holder illustrating slots formed in the footrest;

FIG. 4 is a perspective view taken from the front, right side of a cell phone holder in the form of an above-table x-ray transillumination apparatus;

FIG. 5 is a perspective view of the cell phone holder of FIG. 4 with a cell phone disposed on the holder; and

FIG. 6 is a perspective view taken from the front, left side of the cell phone holder and cell phone of FIG. 5.

### DESCRIPTION OF THE PREFERRED EMBODIMENTS

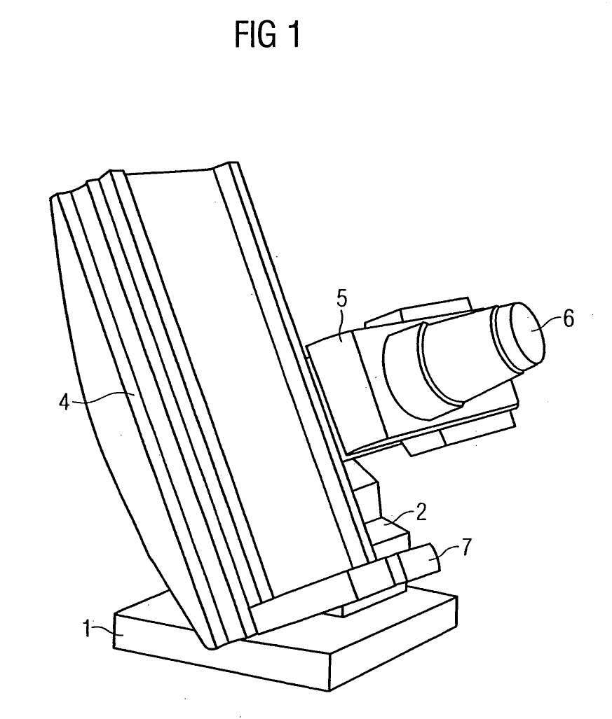

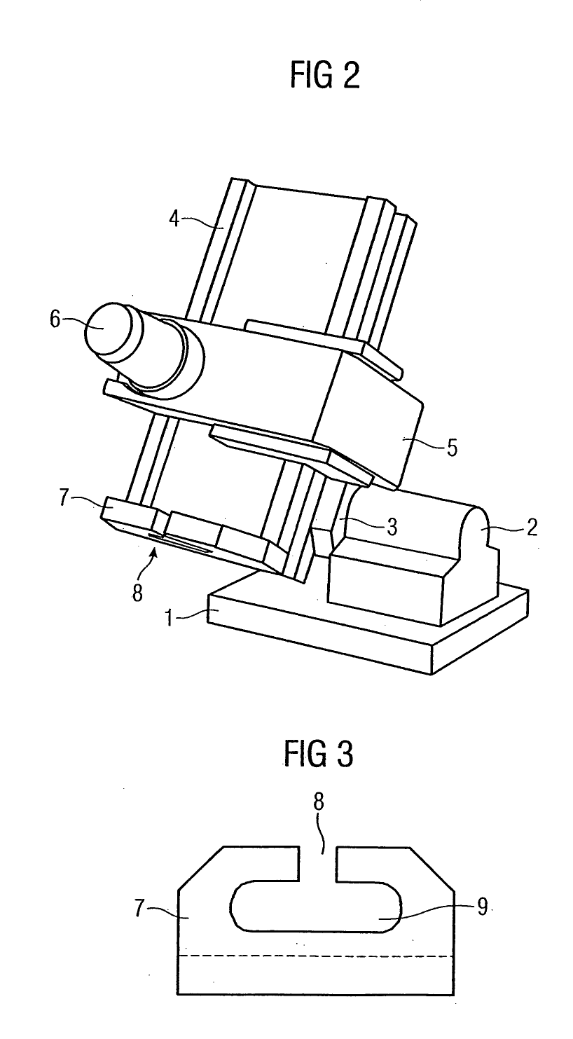

The principles of the present invention can be incorporated in the embodiment of a storage device for a mobile telephone, what is known as a cell phone holder, that is based on the universal under-the-table x-ray apparatus and is shown in FIGS. 1 and 2. The storage device includes a floor plate or base 1 on which is mounted a post 2 that is connected via a swivel joint 3 with a telephone support 4 in the form of a patient positioning device known in medical x-ray apparatuses. On the telephone support 4, a model of an x-ray image intensifier 6 is held over the telephone support 4 via a multi-part elbow or C-shaped carrier 5. A footstool or footrest provided on one end of the patient positioning device of the telephone support 4 is provided with a slot 8, which can allow passage of a charge cable of a mobile telephone, which is supported on the telephone support 4.

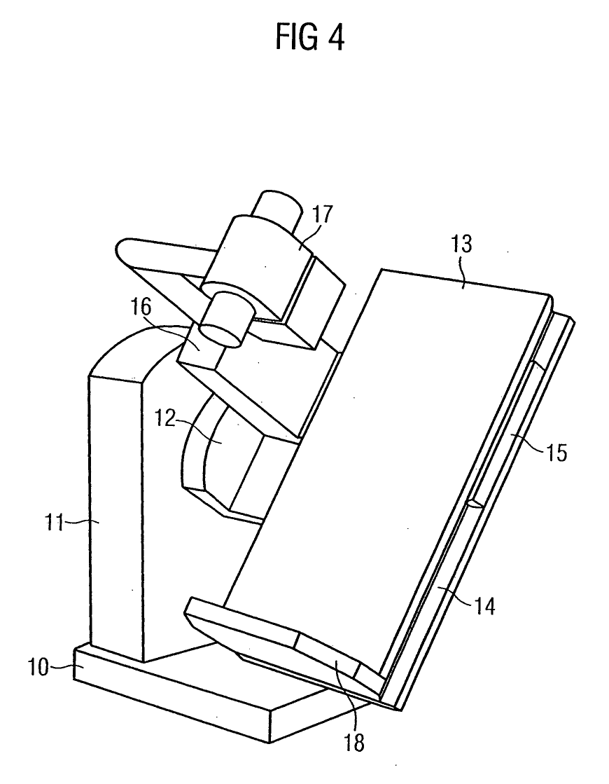

The slot 8, as shown in FIG. 3, is a narrow slot in the upper region, so that only the cable can pass therethrough. In a lower region, it exhibits a wide oblong hole or aperture 9 aligned transverse to the actual slot 8. This oblong hole serves for accepting a wide charge plug of the charge cable, so that the telephone possesses a secure footing, since the charge plug prevents an accidental slippage.

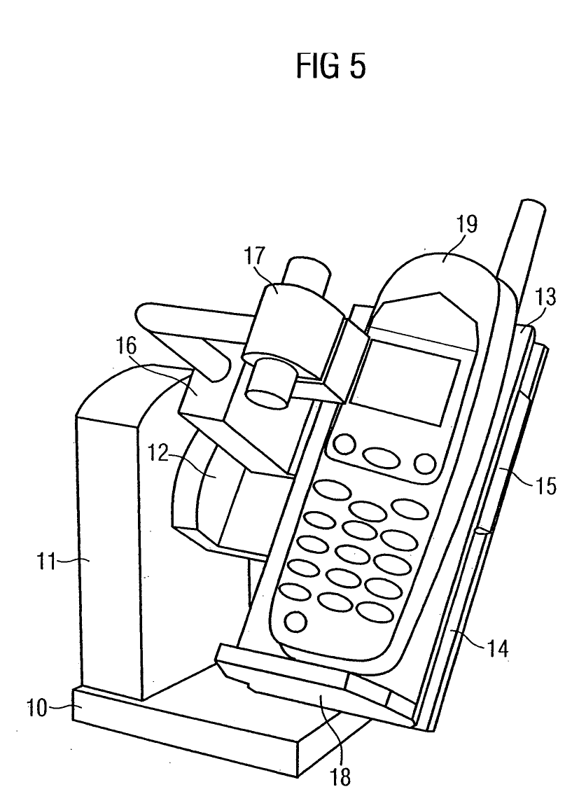

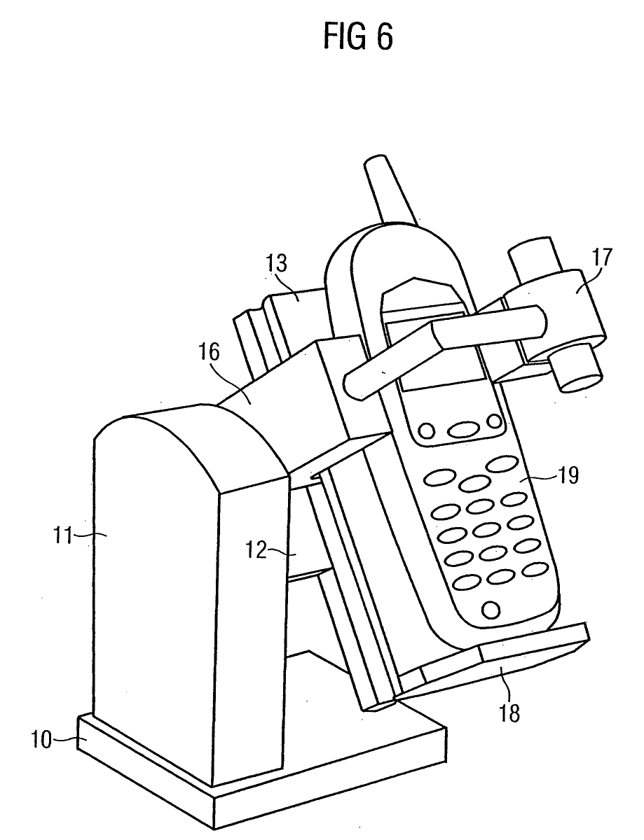

Another embodiment of the cell phone holder is illustrated in FIGS. 4-6 and has the form of an above-table x-ray apparatus. The cell phone holder, as illustrated in FIGS. 4-6, comprises a floor plate or base 10 having an upstanding post 11 arranged laterally thereon. A holder 12 is connected with the post so that it can rotate around a transverse axis and supports a telephone support 13, which is constructed similar to a patient positioning table or support.

The telephone support 13 has a groove 14 on one side, in which is located, at one location, a rectangular elevation that represents a planar x-ray detector 15 arranged beneath the patient positioning device.

A two-part angle support 16 that bears an x-ray radiation source or radiator 17 over the telephone support 13 is mounted on the holder 12. This two-part angled support 16 is formed of a lower part with a rectangular cross-section and an upper part with a round cross-section. This cell phone storage device also includes a footstool or footrest 18 to support the cell phone 19 on the telephone support 13.

In the subject matter according to FIGS. 4-6, the footstool 18 can also be provided with a slot similar to the slots illustrated in FIG. 3.

A model of a medical examination apparatus is, thus, shown as a cell phone holder. Such a cell phone holder, combined with the model of a medical apparatus, can permanently maintain the reminder of the successful purchase of such a system.

The present cell phone storage can be formed of simple components, such as, for example, wood or plastic. It can also be formed both of plastic and wood, which parts are skillfully combined.

A cell phone holder is, thus, obtained that can be quickly and economically produced and, at the same time, as a finished product forms a significant-looking model of an x-ray apparatus.

Although various minor modifications may be suggested by those versed in the art, it should be understood that we wish to embody within the scope of the patent granted hereon all such modifications as reasonably and properly come within the scope of our contribution to the art.

1. A device to store a mobile telephone, said device having a floor plate, a telephone support adjustably attached thereto, said telephone support having a form of a medical patient positioning device.

2. A device according to claim 1, wherein the telephone support is laterally attached to a post for rotation, so that the support can be tilted around a transverse axis.

3. A device according to claim 2, which includes a model of an x-ray technical component being attached to the telephone support via an angular carrier.

4. A device according to claim 3, wherein the telephone support includes a footrest extending from one end thereof.

5. A device according to claim 4, wherein the footrest includes a slot in the middle of the footrest.

6. A device according to claim 5, wherein the footrest has an oblong hole aligned transverse to the slot.

7. A device according to claim 3, wherein the x-ray technical component is an x-ray radiator.

8. A device according to claim 3, wherein the x-ray technical component is an x-ray image intensifier.

9. A device according to claim 2, wherein the telephone support has a groove on one side in which is located, at one location, a rectangular elevation that represents a planar x-ray detector under a patient positioning device.

10. A device according to claim 1, which is constructed from wood.

11. A device according to claim 1, which is formed from plastic.

12. A device according to claim 1, wherein the telephone support includes a flange at one end having a shape of a footrest for a medical patient positioning device.

13. A device according to claim 12, wherein the flange is provided with a slot in the middle of the flange.

14. A device according to claim 13, wherein the flange adjacent to the slot has an oblong aperture aligned transverse to the slot.

15. A method of storing a mobile telephone comprises providing a model of a medical diagnostic apparatus having a floor plate, a post extending from the floor plate and a telephone support adjustably attached to the support and having the form of a medical patient positioning device with a footrest at one end, and placing the mobile telephone on the telephone support with one end of the phone resting on the footrest.
